(19) United States
(12) Patent Application Publication
(10) Pub. No.: US 2009/0300751 A1
(43) Pub. Date: Dec. 3, 2009

(54) Unique packet identifiers for preventing leakage of sensitive information

(76) Inventors: Balachander Krishnamurthy, New York, NY (US); Saurabh Kumar, Richmond (CA); Lakshminarayanan Subramanian, New York, NY (US)

Correspondence Address: AT & T Legal Department - WS;Attn: Patent Docketing, Room 2A-207, One AT & T Way, Bedminster, NJ, 07921, US

(21) Appl. No.: 12/156,371

(22) Filed: May 30, 2008

(51) Int. Cl. H04L 9/00; G06F 21/00

(52) U.S. Cl. 726/13; 726/11

(57) ABSTRACT

In accordance with an aspect of the invention, leakage prevention is implemented by: a) associating—within a network—a unique identifier with a packet transmitted by a process which has previously accessed data containing sensitive information, and b) searching a packet before it exits a network for the unique identifier. This mechanism provides a strong guarantee against leakage of sensitive data out of a network by facilitating the monitoring of packets which potentially contain the sensitive information. The unique identifier may be located in the header of the packet, which is detectable without requiring a heavy investment of network resources. Additionally, a packet's movement within a network may be tracked by analyzing trapped system calls. Furthermore, an exiting packet may be analyzed by a network firewall, the firewall utilizing various policies to determine how to proceed when a packet containing a unique identifier is located.

### BACKGROUND OF THE INVENTION

The present invention relates generally to data monitoring, and more particularly to monitoring data exiting a network.

The need to analyze traffic leaving an enterprise (“exit traffic analysis”) has been underemphasized by the networking community. The ever-growing number of data leakage incidents involving sensitive data is resulting in hundreds of millions of people being exposed to sensitive-information theft every year. Accordingly, there is a need to develop new exit traffic analysis techniques for data leakage detection and prevention.

Exit traffic analysis for data leakage may be divided into two distinct categories, a) leakage prevention before any leakage and b) leakage detection after leakage (“post-facto leakage detection”). An important goal of data leakage prevention is the development of a mechanism that will prevent an unauthorized user or process from leaking any one of a given set of pre-identified files containing sensitive information. An important goal of post-facto leakage detection is the development of a mechanism that will determine which data from files containing sensitive information have already leaked from the enterprise and are publicly available, for example, on the Internet.

Various approaches have been attempted to address the problem of an unauthorized user or process leaking pre-identified files containing sensitive information to the public. Recent work on the leakage prevention problem may be categorized as: end-host approaches, firewall-based approaches, or tailored solutions for specific applications like web browsers.

Various end-host approaches have been suggested. One possible approach in this area is to use secure operating system (OS) designs which provide strong security guarantees at an end-host level. The basic idea used in both these systems is the assignment of a capability to each data item at the kernel level to ensure that only appropriate user-level processes have the ability to access the data item. Another OS level mechanism monitors individual processes to identify if the output of any process contains sensitive data. This is accomplished by modifying the kernel and maintaining a lightweight copy of the process to check for sensitivity. One of the main problems with current OS level solutions is deployment. All the existing approaches in this space require substantial modifications at the kernel level and hence a recompilation of the kernel. The potential cost which would be incurred by an enterprise in completely overhauling its network is very high and can act as an impediment to deployment.

Firewall-based approaches have also been recently proposed. Firewall-based approaches inherently need to use “rules” to inspect an outgoing packet. Therefore, solutions in this space may be limited to the specific environments for which their rules apply. A fundamental limitation of pure firewall based approaches is that they are restricted both in the types of leakages and the types of applications they can handle.

Some recent work has involved secure versions of Web browsers which provide stronger leakage guarantees. These mechanisms, however, are restricted to Web browsers and cannot be extended to other applications. Additionally, some of these also require OS level modifications.

To generalize, current leakage prevention practices are largely ad-hoc without strong leakage guarantees and are therefore of limited efficacy.

An attempt to establish a leakage prevention mechanism with stronger leakage guarantees may encounter several limitations. A first limitation is the need to take into account transitional aspects of “sensitivity”. For example, if a process accesses a first file which contains sensitive information, and subsequently generates a second file, the second file may potentially contain some or all of the sensitive information from the first file.

A second limitation arises due to movement of a file containing sensitive information as one or more packets across end-hosts and servers within a network. In order to monitor the sensitive information and prevent leakage, these packets must be tracked during their internal network transit. Otherwise, it will not be known which processes, end-users, and servers have had access to the sensitive information. Without this knowledge, it would be difficult to know if subsequent transmission of a packet from the process, end-user, or server, out of the network actually contains sensitive information.

A third limitation is the need for the leakage prevention mechanism to be equipped to stop leakage initiated either by an end-user or a process on a server.

A fourth limitation is that in order to facilitate implementation, it is desirable for the mechanism to be non-intrusive, lightweight, and flexible. “Non-intrusiveness” requires that minimal changes be made to the end-hosts and network servers. The overhead of leakage detection or prevention at any point within the enterprise should be “lightweight” and, thereby, not affect the system performance. Finally, there should be enough “flexibility” for an enterprise to specify policies to handle sensitive data leakage.

### SUMMARY

In accordance with an aspect of the invention, the above limitations are avoided by: a) associating, within a network, a unique identifier with a packet that has been transmitted by a process which has previously accessed a file containing sensitive information, and b) searching a packet before it exits a network for the unique identifier. This mechanism provides a strong guarantee against leakage of sensitive data out of a network by facilitating the monitoring of packets which potentially contain the sensitive information.

In accordance with one aspect of the invention, a non-invasive and lightweight mechanism for monitoring sensitive information may be achieved by adding to the header of a packet a marker which serves as the unique identifier for the packet. Alternatively, the marker is added to the data payload section of the packet. In another alternative, an embedded signature is identified within the existing data contained in the data payload section of the packet.

In accordance with another aspect of the invention, a non-invasive and lightweight mechanism for monitoring packet movement may be achieved by analyzing trapped system calls. Analysis of trapped system calls may be used to track the movement of sensitive information within a host, such as a server and an end-user computer. Alternatively, analysis of trapped system calls facilitates tracking the movement of sensitive information within the network of an enterprise.

In accordance with a further aspect of the invention, when a first process accesses a file containing sensitive information, the first process is labeled as tainted. The file itself containing the sensitive information may contain a unique identifier such as an embedded signature associated with data already present in the file, or a marker added to the file. When the tainted first process sends out a packet, a unique identifier may be associated with that packet. This unique identifier may be used to facilitate tracking of the packet's movement. Additionally, if the packet is transmitted to a second process, then the second process may also be labeled as tainted. Furthermore, when the tainted second process transmits a packet, a unique identifier may be associated with that packet. The unique identifier may be similar to the unique identifier associated with a packet transmitted by the first process. Alternatively, the unique identifiers on the two packets may be different from one another.

In accordance with another feature of the invention, a network firewall is used to analyze outgoing packets for the presence of a unique identifier. Furthermore, policies may be implemented to determine what should be done when a packet containing a unique identifier is detected by the network firewall. These policies provide flexibility to an enterprise by allowing the enterprise to customize the policies to their specific needs.

These and other advantages of the invention will be apparent to those of ordinary skill in the art by reference to the following detailed description and the accompanying drawings.

### BRIEF DESCRIPTION OF THE DRAWINGS

FIG. 1 is a schematic representation of a file leakage prevention mechanism according to an aspect of the invention.

FIG. 2 is a flowchart which is used to illustrate a method of leakage prevention according to an aspect of the invention.

FIG. 3 is a high level block diagram of a computer with which the invention can be implemented.

### DETAILED DESCRIPTION

Exit traffic analysis for data leakage may be divided into two distinct categories, a) leakage prevention before any leakage and b) leakage detection after leakage (“post-facto leakage detection”). Current leakage prevention practices used in enterprises are largely ad-hoc without strong leakage guarantees and are therefore of limited value. They can be classified into five categories: (a) end-host level protection; (b) authentication servers; (c) data leakage gateways; (d) disk encryption; (e) policies. End-host prevention mechanisms involve setting up simple access control rules for users and data, with no security guarantees. Authentication servers act as capability-based servers with access control rules that are used to provide authorization to different users or processes before they can access any sensitive data. Their usefulness is fairly limited to the case of restricting adversarial users within the enterprise from potentially obtaining direct access to sensitive information. Data-leakage gateways are firewalls or middle-boxes within the enterprise network that inspect outgoing traffic to detect data leakage. The current design using simple pattern matching rules based on regular expressions to detect whether packets carry sensitive data, is very restrictive in scope. Disk encryption is a common technique used to deal with device leakages. Stolen laptops or hard-disks with encrypted disks deny thieves access to the data. Finally, policies refer to various practices that employees within enterprises should follow to curtail the possibility of data leakage from the enterprise. Given these various leakage prevention techniques, it is most important to note that none of them offer strong security guarantees against data leakage.

In addressing the limitations found in current practices, it is helpful to break down the data leakage problem into three primary areas of complication. A first complication may be described as the transitional relationship of “sensitivity”. If a process touches a sensitive file and writes data to a new file, the new file can be potentially considered sensitive data. Sensitive data herein is any information whose leakage could potentially harm the enterprise in some way. A second complication arises due to data movement across hosts and servers where one needs to track sensitivity across hosts and servers. A third complication is that purely firewall based solutions are insufficient since firewalls do not have any knowledge about the flow of sensitive information within an enterprise.

In an enterprise environment, at least two avenues of leakage of sensitive information should be addressed. A first avenue of leakage is user-level process leakage. Applications such as Web browsers, as well as user-level malware processes can leak data without the knowledge of the users. Two sub-groups of malware are user-level malware and malware that compromise a host. This distinction is helpful since the ability to defend against these two different types of malware is different.

A second avenue of leakage is user-sourced leakages. This second avenue of leakage captures those cases where a user within the enterprise is the source of the leakage. One common avenue of data leakage in this case is where the user uses the Internet to communicate a piece of sensitive data to the external world. The cause of the leakage can be accidental or intentional. Intentional leakages occur when a user explicitly transmits sensitive information out of the enterprise. Accidental leakages may occur due to users unknowingly placing sensitive documents within a public domain where external entities like web crawlers can access the data.

A network of an enterprise, in a simplistic model, basically consists of three entities: end-hosts, data servers and firewalls. Users connect to the enterprise through the end-hosts and data is stored both at the data servers and at the end-hosts. Any external traffic from or to any end-host or server traverses a firewall capable of inspecting bi-directional traffic. Hosts and servers within the enterprise communicate internally without traversing the firewall.

Given an initial pre-specified set of files containing sensitive information located at end-hosts and data servers, a goal of a data leakage prevention mechanism is to stop an adversarial user or malicious process from leaking sensitive data out of the enterprise through the network.

Additionally, to make a data leakage prevention mechanism more easily compatible with enterprises' existing network, it is desirable that the mechanism be non-intrusive, lightweight and flexible. “Non-intrusiveness” requires that minimal changes be made to the end-hosts; one should not require any modifications of the kernel or changes to commodity software deployed in end-hosts. The overhead of leakage detection or prevention at any point within the enterprise (application-, host-, and firewall-level) should be “lightweight” and, thereby, not affect the system performance. Finally, there should be enough “flexibility” for an enterprise to specify policies to handle sensitive data leakage. For example, not all sensitive data that is leaked from an enterprise needs to be blocked; in certain scenarios, a user may genuinely want to send specific sensitive data across the Internet to a specified destination.

In accordance with an aspect of the disclosed invention, the above problems and limitations are avoided by: a) associating—within a network—a unique identifier with a packet that is transmitted by a process which has previously accessed a file containing sensitive data, and b) searching a packet before it exits a network for the unique identifier. This mechanism provides a strong guarantee against leakage of sensitive data out of a network by facilitating the monitoring of packets which potentially contain the sensitive information.

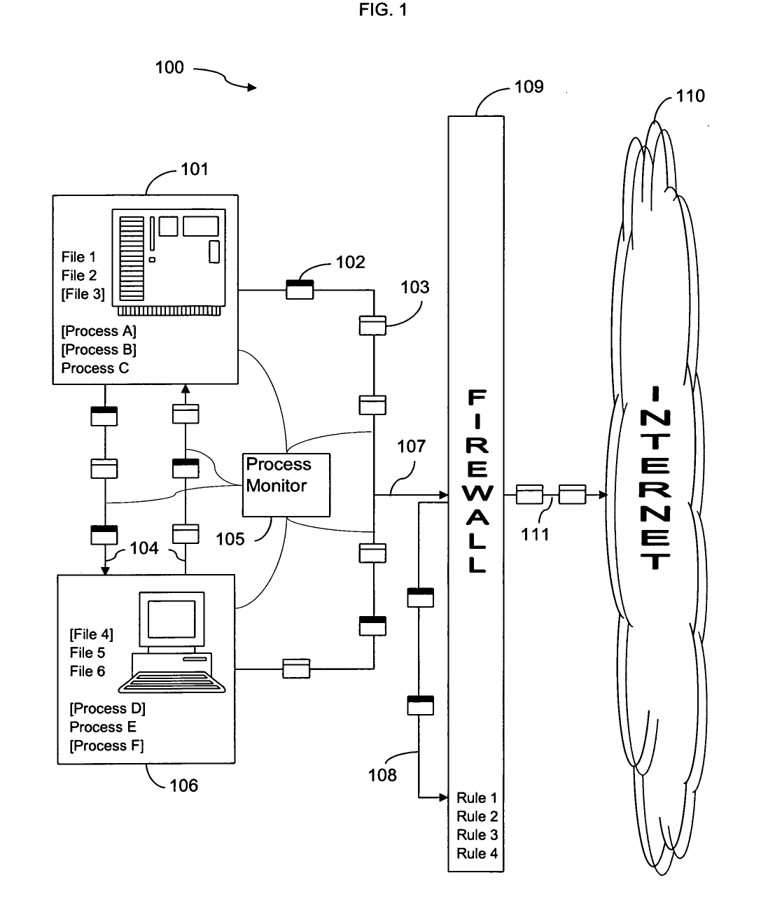

FIG. 1 is a schematic representation of a file leakage prevention mechanism, 100, according to an embodiment of the invention. Multiple files are stored on a data server 101 and an end-host 106. Only the files that have brackets around them contain sensitive information. Therefore, only file 3, which is stored on the data server, and file 4, which is stored on the end-host, contains sensitive information.

In this embodiment, two of the basic components of the system are 1) a process monitor, 105 and 2) an exit firewall, 109. The process monitor can track the flow of sensitive data within a host, across hosts, and to the firewall. A host is, for example, a data server or an end-host, where a user would connect to the network. A process becomes tainted when it accesses sensitive information. Tainted processes are represented on the figure with brackets around the process name. In the figure, processes A and B on the data server and processes D and F on the end-host are tainted. Sensitive information is accessed when a process opens a sensitive file or receives information from some other tainted process on any host inside the enterprise. A process monitor is a shared library installed on all enterprise hosts to track all the tainted processes that are capable of sending sensitive information.

To monitor data flow once the data is transmitted from a data server or an end-host, i.e. at a network level, the flow of sensitive information may be tracked using packet marking. Whenever sensitive information leaves a host, the process monitor “marks” any outgoing packet 102. A packet 103 leaving a host which is not suspected to contain any sensitive information is not marked, such as when the packet was generated by an untainted process. If the packet is meant for an internal host, the process monitor uses the marking to track sensitive data movement across hosts 104. The marking may involve adding a mark to a packet header.

When a marked packet leaves the network 107, the exit firewall detects the packets. Packets which do not contain a marking may be allowed to leave the network 111 and proceed to the Internet 110. Packets which do contain a marking may be delayed from leaving the network in order to process the packet based on certain policy or rules 108. For example, one policy may be to drop all marked packets. However, such a policy may be undesirable, since an enterprise may want some of the marked packets to exit at the firewall will. Therefore, a more intricate policy setup may be established which uses more discretion in determining which packets to drop and which packets to permit exiting the firewall.

A few of the characteristics of this embodiment are as follows. First, once a process becomes tainted it remains tainted for its lifetime, or, perhaps, until an authorized entity changes its status to unmarked. This assumption may be made because once a process reads a file containing sensitive information; the process can copy or manipulate the sensitive information in a transmitted packet anytime in the process's entire lifetime. In an alternative, time bounds may be associated with the tainting of specific applications.

Second, anything produced by such a process is tainted. For example, if the process creates a file, the file is tainted since it may contain sensitive information. Additionally, if this first process communicates with another, second process, the second process becomes tainted. This is accomplished by tainting packets, the packets serving as the means for communication between the two processes. Furthermore, when the second tainted process transmits a packet, a marking may also be associated with that packet. This marking may be similar to the marking placed on a packet transmitted by the first tainted process. Tainting all products of the first and second processes—whether the product is a file or a packet—is important due to the challenge of distinguishing if any sensitive information has made its way into the file or packet.

All the steps of accessing or sending sensitive information may be done via system calls. Access, writing, and sending information may be monitored by trapping these system calls. [Bala: Are there other methods for detecting the flow of information in a network besides trapping system calls? If so, please describe them so that we can include them as possible embodiments for performing the method of the invention.] For example, in Unix environments, one can trap system calls using the LD PRELOAD shared library mechanism without having the need to make any kernel modifications. Therefore, the monitoring mechanism is non-invasive and hence more easily deployable than a monitoring mechanism which requires kernel modification. A similar mechanism exists for other operating systems; hence, the idea is extendable to other environments. These monitoring mechanisms, such as LD PRELOAD, are also fairly lightweight, meaning that they incur minimal performance overhead.

The following describes the function of the exit firewall 109. After marking sensitive information inside the enterprise, there is a need to check exiting traffic, 107, to identify leakage. When an exiting packet is determined to contain a unique identifier, policies/rules, 108, may be used to decide which of the marked packets constitute an unauthorized leakage. As the definition of sensitive information varies from enterprise to enterprise, policies may also vary. Additionally, varying degrees of sensitivity may also be defined in the policies. The following are an exemplary set of policies. The goal of this listing is to illustrate some policies which may be sufficiently broad as to provide guidelines for policy generation in various enterprises:

a. The Sensitivity of the File:
Certain data on the host might be extremely sensitive and can never be permitted to exit the network. There might be some files that are only somewhat sensitive such that the data may be permitted to transit the firewall in various circumstances.
b. Type of process:
There are certain applications which regularly touch sensitive files. For example, when the secure shell (SSH) application (which is a network protocol that allows data to be exchanged over a secure channel between two computers) opens the file “.id rsa”, it should not cause an alarm. But if some other process like a web browser touches the file, it should raise an alarm. [Bala: Please provide a definition of “.id rsa”.]
c. Network Access Profile of End-Hosts:
There might be certain hosts which send legitimate sensitive information to each other.
d. File Access Profile of Processes:
If a process opens certain random sensitive files we might consider that sensitive. If SSH opens different sensitive files in different runs, this should not cause an alarm.

Some possible functions performed by the network firewall to a packet found to contain a unique identifier are: dropping the packet, delaying the packet's transmission to allow for a more thorough analysis, or permitting the packet to exit the network without additional delay.

The present mechanism for preventing data leakage, in one embodiment departs from previous work in the leakage detection arena. The present mechanism may utilize both a process monitor to detect host based data leakage combined with an exit firewall to analyze exiting packets for data leakage. Previous work in data leakage prevention specifically focused in isolation on either end-host based leakage detection or firewall based leakage analysis. Despite obstacles which make it challenging to use these two approaches in tandem, some underlying reasons why this invention uses such a combination approach are two-fold. [Bala: These last few sentences are paraphrased from the beginning of Section 4.1 in your paper. Is there anything counterintuitive about using these two approaches in tandem? (I.e. from a patent law point of view, why would it not be obvious to combine the use of a process monitor with a firewall?)] First, a purely end-host based approach is insufficient since an end-host may not have enough knowledge to decide which potential sensitive data leakages need to be dropped. Enterprises may want to support their own specific policies on what type of packets to drop. Such policies are best implemented at the firewall. Second, pure firewall based approaches are insufficient since they cannot track the transitive relationships across files and data movement across hosts within the enterprise.

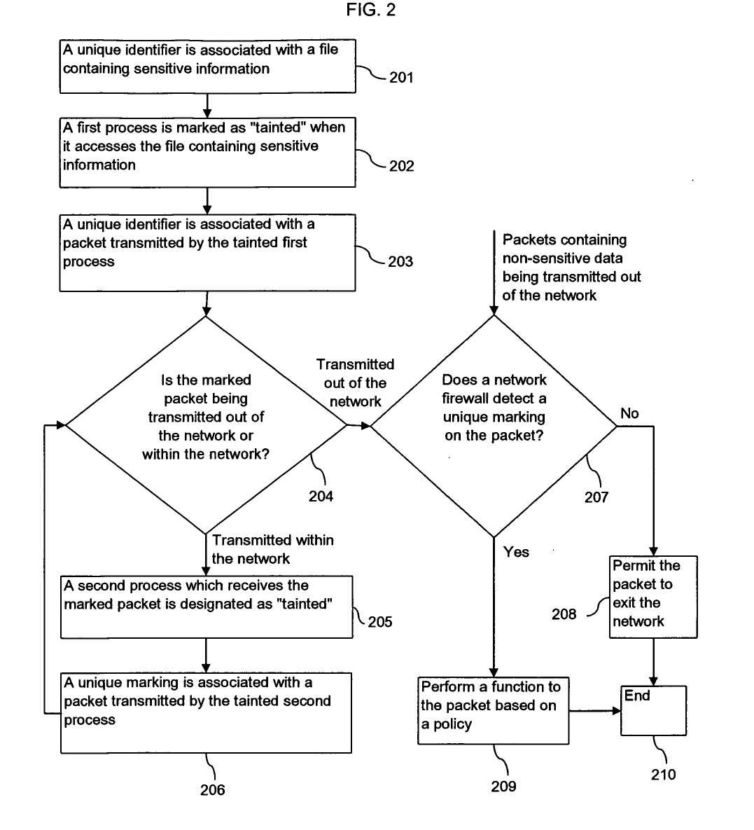

FIG. 2 is a flowchart which is used to illustrate a method of leakage prevention according to an aspect of the invention. The process begins at step 201 by associating a unique identifier with a file containing sensitive information. Knowledge of which files contain sensitive information may be inputted by a representative of an enterprise. The unique identifier may be a marking added to the file. The file may be stored on a host, such as an end-host computer, 106, where a user interfaces with a network, or a data server 101.

Continuing at step 202, when a first process accesses the marked file containing sensitive information, the process itself is marked as “tainted”. The process may be performed on the same host as where the file is stored, such as an end-host computer or a data server.

The method continues at step 203 by associating a unique identifier with a data packet transmitted by a tainted process. The data packet may be transmitted to an entity within the network or outside the network. The transmitted packet may contain data from a file or any other information pertinent to a communication between the first process and the other process. Regardless of the reason for sending the packet or the content of the packet, the unique identifier is associated with the transmitted packet. This unique identifier may be a marking added to the header of the packet.

The movement of sensitive information—both within a host and as it is transmitted from a host—may be monitored by a process monitor. As mentioned previously, all the steps of accessing or sending sensitive information may be done via system calls. Access, writing, and sending information may be monitored by trapping these system calls. For example, in Unix environments, one can trap system calls using the LD PRELOAD shared library mechanism without having the need to make any kernel modifications. Therefore, the monitoring mechanism is non-invasive and hence more easily deployable than a monitoring mechanism which requires kernel modification. A similar mechanism exists for other operating systems; hence, the idea is extendable to other environments. In this embodiment, the process monitor interacts with another process that traps system calls.

Continuing at step 204, it is determined if the marked packet is transmitted out of the network or within the network. If the marked packet is being transmitted within the network, for example, to another process, then the process continues at step 205. If the packet is being transmitted out of the network, then the process continues at step 207.

At step 205, a second process which receives the marked packet and is designated as “tainted”. This tainting allows for the continued monitoring of the sensitive information, even though it may be stored or presented in an altered form than in the original file.

At step 206, the second process, which is now tainted, transmits a data packet to another entity. Similar to step 203, the transmitted data packet is marked with a unique identifier. This unique identifier may be a marking added to the header of the packet. The method then returns to step 204 where it is determined if the packet is being transmitted within the network or outside the network.

When a marked packet is transmitted from a tainted process to another process, the process receiving the transmission is also labeled as tainted. Furthermore, when this newly tainted process transmits a packet, a marking is associated with that packet. This marking may be similar to the marking placed on a packet transmitted by the originally tainted process. Alternatively, the unique identifiers on the two packets may be different from one another.

When the packet is being transmitted out of the network, then, at step 207, a network firewall may be used to analyze the packets. In addition to receiving packets from tainted processes, the firewall also receives packets from other, non-tainted, processes. Packets from non-tainted processes do not contain unique identifiers. A responsibility of the firewall is to detect if there is a unique marking on the packet, indicative that the packet may contain sensitive information. If no unique identifier is detected by firewall, then, at step 208, the packet is permitted to leave the network, and the process ends at step 210.

However, if the packet does contain a unique identifier, then the process continues at step 209. At step 209, a function is performed to the packet based on an established policy. An enterprise may establish policy unique for its specific circumstances. Examples of functions perform include: a) dropping the packet before it exits the network, b) delaying the transmission of the packet thus allowing for a more detailed assessment concerning whether the packet should be transmitted, or c) allowing the packet to exit the network. The process ends at step 210.

Some alternatives to the embodiment described in FIG. 1 are as follows.

Instead of the marking, i.e. unique identifier, being added to a packet header, the marking may be added to the data payload section of the packet. Alternatively, instead of adding a marking, an embedded signature may be identified within the existing data contained in the data payload section of the packet.

Instead of marking a packet transmitted by a second tainted process with the same unique identifier as that which is placed in a packet transmitted by a first tainted process, the unique identifiers on the two packets may be different from one another.

Instead of using just one process monitor, multiple process monitors may be used collectively keep track of the flow of sensitive information inside the enterprise.

Some alternatives to the embodiment as described in the flowchart in FIG. 2 are as follows.

Instead of a representative of an enterprise entering a listing of the files containing sensitive information owned by the enterprise, some other party may enter this data. Alternatively, this data may be automatically determined based on some indication in a file that it contains sensitive information.

Instead of adding a unique identifier to a file containing sensitive information, an embedded signature may be identified from within the data itself.

Instead of a unique identifier being a marking added to the header of the packet, the unique identifier may be a marking added to some other part of the packet, such as the data payload. Alternatively, the unique identifier may be an embedded signature identified within some data stored in the packet, such as data found in the data payload. These qualifications may apply whether the packet is transmitted by a first process or any subsequent process.

Instead of the process monitor interacting with a process that traps system calls, the process monitor itself may be enabled to trap system calls.

Instead of an enterprise establishing policy for the operation of a firewall, default policy settings may be used.

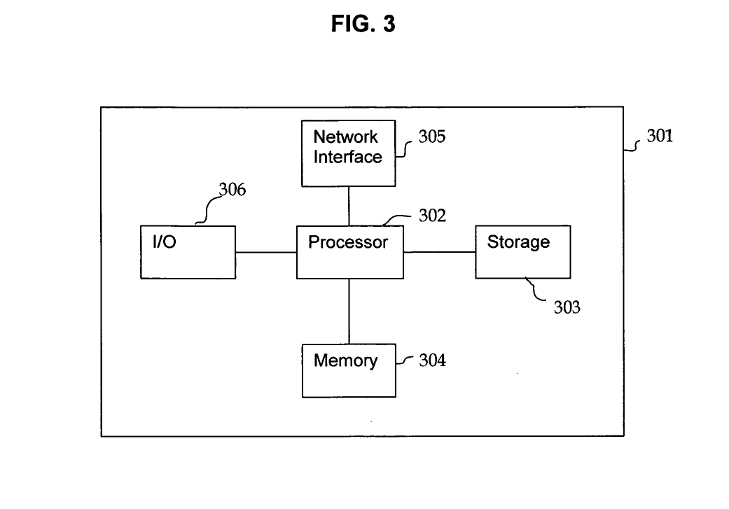

A high level block diagram of a computer with which the invention can be implemented is illustrated in FIG. 3. Computer 301 contains a processor 302 which controls the overall operation of the computer 301 by executing computer program instructions which define such operation. The computer program instructions may be stored in a storage device 303 (e.g., magnetic disk) and loaded into memory 304 when execution of the computer program instructions is desired. Thus, the method steps described herein can be defined by the computer program instructions stored in the memory 304 and/or storage 303 and executed by the processor 302. The computer 301 may also include one or more network interfaces 305 for communicating with other devices via a network. The computer 301 also includes input/output devices 306 that enable user interaction with the computer 301 (e.g., display, keyboard, mouse, speakers, buttons, etc.) One skilled in the art will recognize that an implementation of an actual computer could contain other components as well, and that FIG. 3 is a high level representation of some of the components of such a computer for illustrative purpose.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for monitoring data comprising:
within a network, associating a unique identifier with a packet transmitted by a process which has previously accessed data containing sensitive information; and
before the packet exits the network, searching the packet for the unique identifier.

2. The method of claim 1 where the searching of the packet comprises using a network firewall.

3. The method of claim 2, further comprising:
processing the packet in response to the network firewall finding the unique identifier in the packet.

4. The method of claim 3 where the process comprises:
dropping the packet before the packet leaves the network.

5. The method of claim 1 where the unique identifier comprises a marker added to a header of the packet.

6. The method of claim 1 wherein a data is identified as containing sensitive information based on an embedded signature located within the data.

7. A method for monitoring data comprising:
designating a process as tainted when the process accesses data containing sensitive information;
labeling, with a unique identifier, a packet that has been transmitted by the process designated as sensitive; and
analyzing packets before they leave a network for the presence of the unique identifier.

8. The method of claim 7 further comprising:
tracking the movement of the packet within the network by analyzing trapped system calls.

9. The method of claim 8, when the labeled packet is transmitted to a second process within the network, further comprising:
designating the second process as tainted; and,
labeling a packet transmitted by the second process with a unique identifier.

10. The method of claim 9 further comprising:
processing a packet in response to detection of a the unique identifier.

11. A data monitoring system comprising:
a process monitor adapted to associate a unique identifier with a packet transmitted from a first process that had previously accessed data containing sensitive information; and
a packet analyzer adapted to analyze a packet for the presence of the unique identifier, before the packet leaves a network.

12. In the system of claim 11, the process monitor further adapted to taint the first process after the process has accessed data containing sensitive information, and to associate a unique identifier with packets transmitted from the tainted process.

13. The system of claim 11, where the association of the unique identifier with the packet comprises adding to the packet a unique marker.

14. The system of claim 13, where the said unique marker is located in a header of the packet.

15. The system of claim 11, where the association of a unique identifier with the packet comprises identifying an embedded signature within the data payload section of the packet.

16. In the system of claim 1, the process monitor further adapted to track packet movement within the network.

17. The system of claim 16, wherein the tracking of packet movement within the network comprises analyzing trapped system calls.

18. The system of claim 17, further comprising a process monitor adapted to associate a unique identifier with a packet transmitted from a second process, said second process having received a packet from the first process.

19. An apparatus comprising:
means for associating, within a network, a unique identifier with a packet transmitted by a process which has previously accessed data containing sensitive information; and
means for searching the packet for the unique identifier before the packet exits the network.

20. A computer readable medium encoded with computer executable instructions defining steps comprising:
within a network, associating a unique identifier with a packet transmitted by a process which has previously accessed data containing sensitive information; and
before the packet exits the network, searching the packet for the unique identifier.
